(19) United States
(12) Patent Application Publication
(10) Pub. No.: US 2014/0199596 A1
(43) Pub. Date: Jul. 17, 2014

(54) Sodium-Based Energy Storage Device Based on Surface-Driven Reactions

(71) Applicant: BATTELLE MEMORIAL INSTITUTE, Richland, WA (US)

(72) Inventors: Yuyan Shao, Richland, WA (US); Jun Liu, Richland, WA (US); Jie Xiao, Richland, WA (US); Wei Wang, Kennewick (CN)

(73) Assignee: BATTELLE MEMORIAL INSTITUTE, Richland, WA (US)

(21) Appl. No.: 13/740,878

(22) Filed: Jan. 14, 2013

(51) Int. Cl. H01M 4/38; H02J 15/00; H02J 7/00; H01G 9/00

(52) U.S. Cl. CPC H01M 4/381; H01G 9/155; H02J 15/00; H02J 7/0068
USPC 429/231.8; 429/231.9; 361/502; 320/167; 320/128

(57) ABSTRACT

The performance of sodium-based energy storage devices can be improved according to methods and devices based on surface-driven reactions between sodium ions and functional groups attached to surfaces of the cathode. The cathode substrate, which includes a conductive material, can provide high electron conductivity while the surface functional groups can provide reaction sites to store sodium ions. During discharge cycles, sodium ions will bind to the surface functional groups. During charge cycles, the sodium ions will be released from the surface functional groups. The surface-driven reactions are preferred compared to intercalation reactions.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

A low cost, long lifetime and highly efficient energy storage system can enable large-scale implementation of renewable energy products and electric vehicles. Sodium-based energy storage systems have been considered as an attractive alternative to lithium-based systems since sodium is an earth abundant element and its production cost is very low. Traditional Na ion battery electrode materials (especially cathodes) are based on intercalation reactions. The capacity of Na⁺ intercalation cathode materials is usually limited to ˜120 mAh/g. For higher capacity cathode materials, the capacity fading during cycling is fast. This is mainly because Na⁺ is a large ion (about 50% larger than Li⁺) and Na⁺ insertion/desertion in host materials can be difficult and/or problematic. For example, during Na⁺ insertion/desertion, large structure changes can occur in the intercalation material of the cathode, thereby leading to instability. Therefore, a need exists for improved sodium ion batteries that avoid the problems associated with sodium intercalation in cathodes.

### SUMMARY

This document describes methods and apparatuses for storing energy based upon surface-driven reactions between sodium ions and functional groups attached to surfaces of a cathode in a sodium-based energy storage device. The cathode substrate, which comprises a conductive material, provides high electron conductivity while the surface functional groups provide reaction sites to store sodium ions. The embodiments described herein can exhibit significantly enhanced energy storage capacity, rate capability and especially cycling stability since long-range diffusion (insertion/desertion) of sodium ions need not occur. Accordingly, reaction kinetics are increased and the structure of the electrode is preserved.

One embodiment encompasses a method for operating a sodium-based energy storage cell comprising sodium ions, an anode, and a cathode comprising a substrate. The method comprises binding sodium ions to surface functional groups attached to the surfaces of the substrate during discharge cycles and releasing sodium ions from the surface functional groups during charge cycles. In preferred embodiments, the sodium ions preferentially bind to the surface functional groups relative to intercalating in the substrate. In some embodiments, sodium ions can be adsorbed directly on the substrate surface (i.e., in contrast to sodium ions bound to functional groups attached to the surface) and up to 50% of the storage cell capacity can be attributed to the direct-surface bound sodium ions.

In some instances, the substrate of the cathode can comprise an electrically conductive material that is not a sodium intercalation material. For example, the substrate can comprise carbon, such as hard carbon. Examples of surface functional groups can include, but are not limited to those having oxygen and/or sulfur. Preferably, the functional groups comprise oxygen.

The method can further comprise transferring sodium ions to and/or from an anode that comprises sodium. Examples of anode materials can include, but are not limited to, sodium metal, sodium alloys, sodium intercalation compounds, carbon, and combinations thereof.

Embodiments of the present invention can also encompass sodium-based energy storage cells comprising sodium ions, an anode, and a cathode comprising a substrate. The energy storage cell comprises surface functional groups attached to surfaces of the cathode substrate and by the sodium ions bound to the surface functional groups during discharge cycles.

In some embodiments, the surface functional groups comprise oxygen. The functional groups can alternatively, or in addition, comprise sulfur. The substrate of the cathode can comprise an electrically conductive material. One example includes, but is not limited to carbon. The sodium-based energy storage cell can further comprise an anode. The anode can comprise sodium. Examples of anode materials can include, but are not limited to sodium metal, sodium alloys, sodium intercalation compounds, carbon, and combinations thereof.

In some instances, the energy storage cell can operate as a super capacitor.

In another embodiment, the sodium-based storage cell has a storage cell capacity, wherein 50% of the storage cell capacity is stored in sodium ions adsorbed directly on the substrate surface.

In yet another embodiment, the sodium ions are charge carriers between the cathode and the anode.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a schematic diagram depicting the mechanisms for sodium ion energy storage at the cathode of a sodium-based energy storage cell.

FIG. 2 includes Cyclic voltammograms on functionalized carbon paper (CP-Acid) cathode in a CP-Acid/Na coin cell, a) 1.0 mV/s, b) 0.2-5 mV/s (Inset: linear relationship between redox peak current and scanrates).

FIG. 3 includes a) Discharge-charge curves of CP-Acid/Na cells at the rates from 0.1 A/g to 5 A/g; b) Comparison of discharge-charge curves of CP-Acid/Na, CP-KOH/Na, and CP/Na cells at the rate of 0.1 A/g; c) Ragone plot of various Na cathodes (including embodiments of the present invention as well as cathodes of the prior art for comparison); d) Cycling stability of CP-Acid, CP-KOH and CP electrodes (cycling protocol: repeating cycling of 0.1 A/g-6 cycles/1 A/g-100 cycles; only the 0.1 A/g cycling data are shown here).

FIG. 4 includes SEM images of carbon papers before and after acid functionalization. a) and b) show CP, while c) and d) show CP-Acid.

FIG. 5 includes XPS spectra of CP-Acid electrodes before and after discharge/charge in CP-Acid/Na cells. a) C1s, b) wide scan XPS, which shows the presence of Na after discharge and its disappearance after charge.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

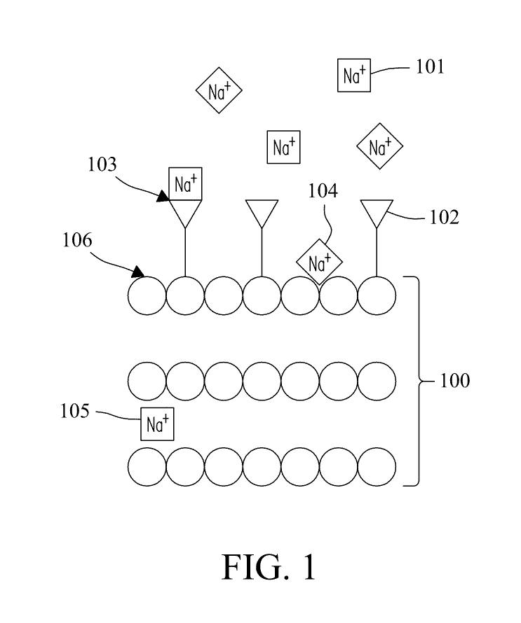

Embodiments described below utilize a surface-driven sodium ion energy storage mechanism based on redox reactions between sodium ions and a cathode comprising functional groups on the surface of a substrate. Referring to FIG. 1, a schematic diagram depicts the interactions between sodium ions and the cathode. Functional groups 102 are attached to the surface 106 of the cathode substrate 100. According to embodiments of the present invention, sodium ions 101 are bound to the surface functional groups 103. Sodium ions can also be bound directly to the surface of the substrate 104. Traditional cathode materials comprise intercalation materials in which sodium ions intercalate 105. However, intercalation is not a significant mechanism for energy storage according to embodiments described herein.

In the examples below, the functional groups comprise oxygen and the substrate comprises carbon. The surface reaction, instead of Na⁺ bulk intercalation reaction, leads to high rate performance and cycling stability due to the enhanced reaction kinetics and the absence of electrode structure change. For instance, some embodiments can deliver at least 150 mAh/g capacity at a rate of 0.1 A/g and a capacity retention of 82% within 10000 cycles (in comparison with tens to hundreds of cycles for the state-of-art sodium ion battery cathode materials).

In one example, sodium coin cells were assembled to operate according to the surface-driven sodium ion storage mechanism described herein. The cells were assembled in an Ar-filled glovebox with moisture and oxygen content less than 1 ppm. Sodium foil and functionalized free-standing carbon paper were used as anode and cathode, respectively. The separator comprised Celgard K1640®, a polyethylene membrane. The electrolyte was 1.0M NaPF₆ in EC/DMC (3:7). The discharge/charge was carried out in the potential range of 1.5-4.2V (vs. Na/Na′) on a battery test station. The cyclic voltammograms (CVs) were recorded on a CHI660® electrochemical workstation.

Battery-grade ethylene carbonate (EC) and dimethyl carbonate (DMC) were utilized in the coin cells. NaPF₆ (98%) was dried under vacuum at 100° C. in glovebox antechamber for 72 hrs before use. In order to simplify the surface analysis and reaction mechanism study, free-standing carbon paper (without binder) was used as cathodes. These high surface area carbon papers (CP) were functionalized using concentrated H₂SO₄/HNO₃ mixed acid. In brief, the carbon papers were put into H₂SO₄/HNO₃ (Vol 3:1) at 80° C. under mild mechanical stirring for 2 hrs; the functionalized carbon papers were washed with DI water and dried in vacuum (80° C., 24 hrs) before use (hereinafter, “CP-Acid”). The KOH activation of carbon paper was carried out under N₂ at 700° C. for two hrs (hereinafter, “CP-KOH”). In brief, carbon paper was soaked in concentrated KOH for 20 min, and then dried in vacuum. The dried KOH-soaked carbon paper was heated to 700° C. under N₂ for 2 hr. Carbon paper was cooled down to room temperature under N₂ and washed with DI water, followed by drying in vacuum for at least overnight.

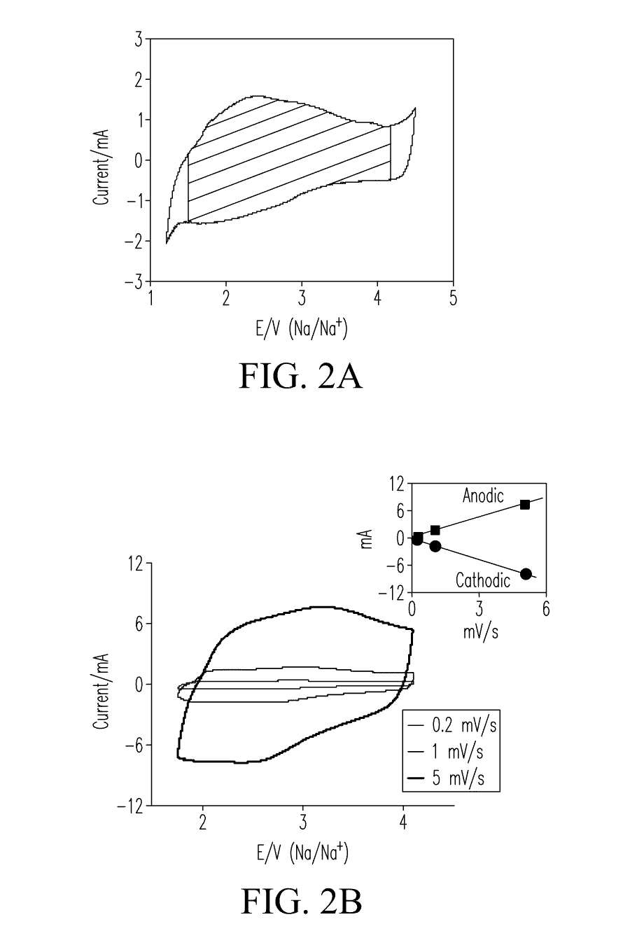

The working potential range of functionalized carbon paper (CP-Acid) electrodes was first determined using CV data. FIG. 2A shows the CV in a CP-Acid/Na cell. Oxidation (electrolyte) occurs above 4.2V and reduction (electrolyte) occurs below 1.5V. Therefore, the potential range of 1.5-4.2V (shadow region) was chosen for subsequent electrochemical tests. Broad redox peaks occur in the CV and are attributed to redox reactions of carbon-oxygen functional groups and Na⁺ (—C═O+Na⁺+e [symbol] —C—O—Na).

FIG. 2B includes CV graphs at various scanrates. The linear relationship between peak currents and scanrates indicates that the redox reaction is confined at the surface of the cathode substrate.

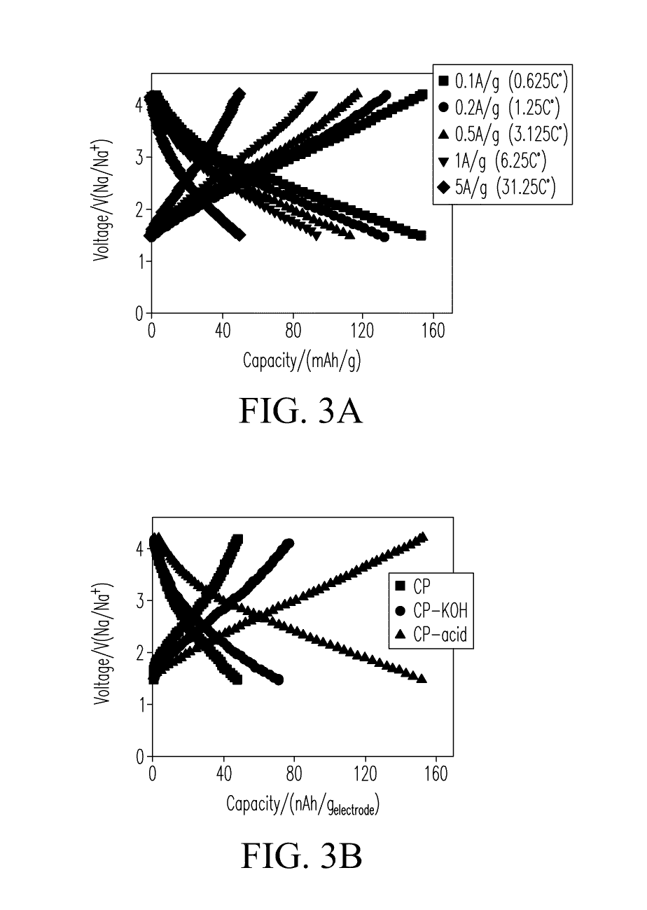

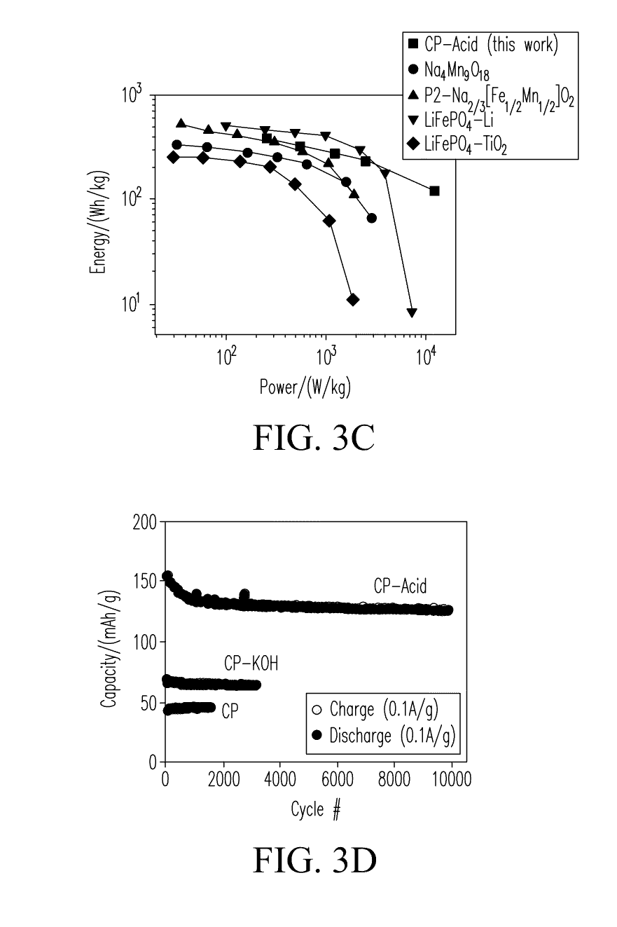

FIG. 3A includes the discharge/charge curves of a CP-Acid/Na cell at various discharge/charge rates. The discharge/charge curves of CP/Na cell and CP-KOH/Na cell are presented together with a CP-Acid/Na cell in FIG. 3B for comparison. A CP-Acid electrode delivers a high capacity of 152 mAh/g with an average discharge cell voltage of 2.58V and an average charge voltage of 2.85V (0.1 A/g, 0.625 C). The rate performance is excellent; the specific capacity is ˜100 mAh/g at the discharge rate of 1.0 A/g (6.25 C) and ˜50 mAh/g at 5.0 A/g (31.25 C). In comparison, CP and CP-KOH deliver a specific capacity of only 46 mAh/g and 70 mAh/g respectively (0.1 A/g). This is consistent with CV results, which show the highest current response for a CP-Acid electrode while CP-KOH and CP shows rectangle-shaped CVs that are characteristic for electrochemical double layer capacitors.

The CP-Acid electrode exhibits improved power/energy capability. The Ragone plot of CP-Acid/Na cathode is presented in FIG. 3C together with two traditional Na-ion battery cathodes, Na₄Mn₉O₁₈ (see Cao, Y. L., et al., Reversible Sodium Ion Insertion in Single Crystalline Manganese Oxide Nanowires with Long Cycle Life. Advanced Materials, 2011. 23(28): p. 3155-3160) and P2-Na_{2/3}[Fe_{1/2}Mn_{1/2}]O₂ (see Yabuuchi, N., et al., P2-type Na-x Fe½Mn½ O-2 made from earth-abundant elements for rechargeable Na batteries. Nature Materials, 2012. 11(6): p. 512-517). P2-Na_{2/3}[Fe_{1/2}Mn_{1/2}]O₂ presents one of the highest known energy storage capacities and Na₄Mn₉O₁₈ shows one of the best known cycling stabilities in the literature. The CP-Acid cathode encompassed by embodiments of the present invention shows superior energy storage/delivery performance than Na_{2/3}[Fe_{1/2}Mn_{1/2}]O₂, especially at high power. Since LiFePO₄ is widely proposed as a Li-ion battery cathode material for stationary energy storage, the Ragone plots of LiFePO₄/Li cell and a more practical LiFePO₄/TiO₂ cell are presented for comparison (see Choi, D. W., et al., Li-ion batteries from LiFePO4 cathode and anatase/graphene composite anode for stationary energy storage. Electrochemistry Communications, 2010. 12(3): p. 378-381). CP-Acid/Na is much better than LiFePO₄/TiO₂ in terms of the rate and energy.

The cycling stability (at changing discharge/charge rates) of CP-Acid, CP-KOH and CP is presented in FIG. 3D. The capacity of CP-Acid electrode drops at the beginning cycles and then becomes flat; the capacity retention for CP-Acid is 82% within 10000 cycles and the capacity is still stable after that. At fixed discharge/charge rate (0.1 A/g), the cycling stability of CP-Acid is even better with 90% capacity retention within 1650 cycles. In comparison, the capacity of a cell having a cathode of Na_{2/3}[Fe_{1/2}Mn_{1/2}]O₂ drops by over 20% within 30 cycles. Cells having Na₄Mn₉O₁₈ cathodes drop by over 20% within 500 cycles.

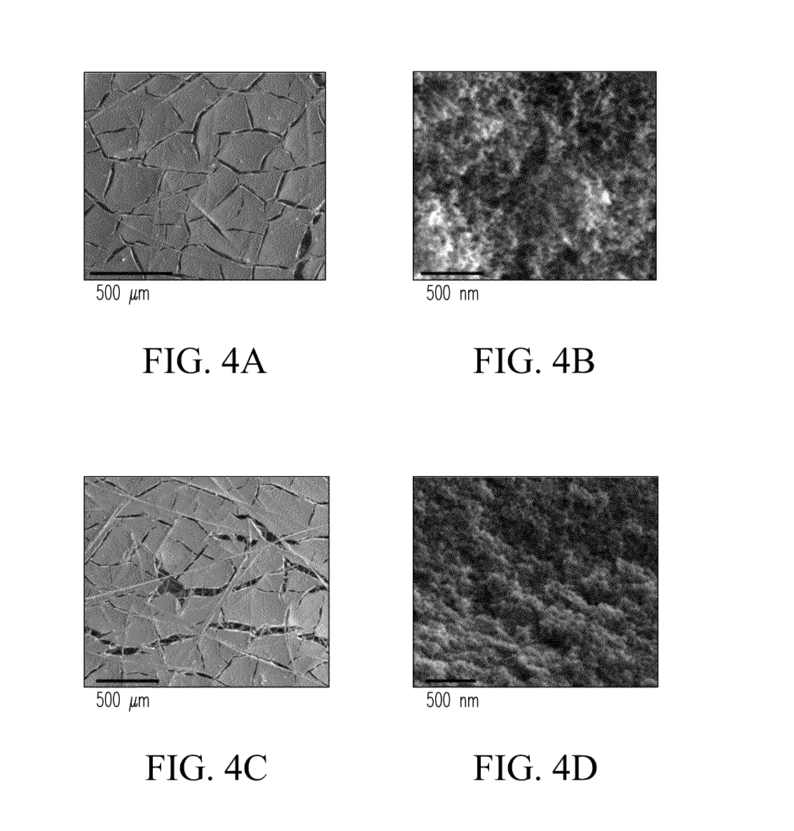

FIG. 4 presents SEM images of CP and CP-Acid. Both CP and CP-Acid electrodes show highly porous structure. But there is no change in the morphology of carbon paper before and after acid functionalization. BET test results show similar pore size/distribution among CP, CP-KOH and CP-Acid. BET surface area is the almost the same for CP and CP-Acid, with an enhanced specific surface area for CP-KOH (Table 1). Comparing CP and CP-KOH, the enhanced capacity of CP-KOH comes from the increased surface area; the two are electrochemical double-layer capacitors. However, the improved surface area does not increase the capacity so high as to be similar to the capacity from CP-Acid cathodes, as CP-KOH only delivers half the capacity of CP-Acid. The 330% improved capacity of CP-Acid in comparison with CP appears to come from other faradic reaction processes instead of double-layer capacitor charge since they have almost the same surface area.

TABLE 1
BET test results of CP-Acid, CP-KOH and CP.

| | CP-Acid | CP-KOH | CP |
|---|---|---|---|
| Surface area (m²/g) | 513.4 | 1082 | 537.4 |
| Pore size (nm) | 17.9 | 17.7 | 17.7 |
| Pore volume (cc/g) | 0.75 | 1.11 | 0.79 |

In the instant example, surface reactions between Na ions and oxygen functional groups (—CO═O+Na⁺+e [symbol] —C—O—Na) appear to be the mechanism contributing primarily to the capacity of CP-Acid. Alternative mechanisms can include 1) the adsorption/desorption of negatively charged PF₆⁻ ion, and/or 2) the bulk insertion/desertion of PF₆⁻. Bulk insertion/desertion is not likely because the working potential of CP-Acid electrode (1.8-4.5V vs Li/Li⁺) during operation is not within the expected range for the insertion/desertion of PF₆⁻ from NaPF₆. XRD analysis also confirms that there is no detectable bulk insertion of PF₆⁻ in CP-Acid electrode because the diffraction peak does not change before and after discharge/charge. The absence of changes in the diffraction peaks means that the d-value between graphene layers does not change as a result of PF₆⁻ insertion/desertion into the substrate.

XPS element analysis indicates that the mechanism is not based on surface adsorption of PF₆⁻ either. The ratio of P/F is 1/52 and 1/29 for a discharged and charged CP-Acid cathode respectively (Table 2), significantly different from the stoichiometry of 1/6 for PF₆⁻. The P/F surface chemistry of discharge/charged electrodes are quite different from PF₆⁻.

TABLE 2
Atomic percentages of Na/P/F/C/O on carbon paper electrodes
(calculated from the high-resolution XPS).

| % | Na | P | F | C | O |
|---|---|---|---|---|---|
| CP | 0 | 0 | 0 | 97.2 | 2.8 |
| CP-KOH | 0 | 0 | 0 | 91.1 | 4.6 |
| CP-Acid (Original) | 0 | 0 | 0 | 77.4 | 22.6 |
| CP-Acid (After | 6.5 | 0.3 | 15.7 | 51.3 | 23.2 |
| discharge) | | | | | |
| CP-Acid (After charge) | 0.2 | 0.5 | 14.5 | 56.6 | 26.5 |

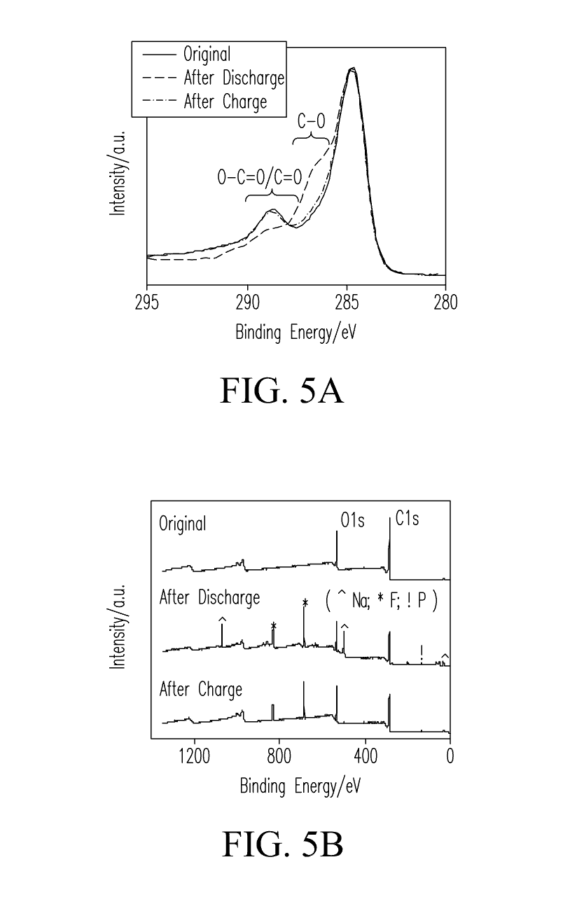

The surface chemistry analysis provides direct evidence of the reaction between oxygen functional groups and Na ions. After acid functionalization, C1s XPS shows a peak on CP-Acid in the binding energy (BE) range of 287-290 eV which can attribute to carbon-oxygen double bond groups (O—C═O/C═O). FIG. 5A shows the C1s XPS of CP-Acid electrode before and after discharge/charge. After discharge, the carbon-oxygen double bond peak (O—C═O/C═O) decreases and a new bump peak appears in the BE range of 285.5-287.5 eV which is attributed to carbon-oxygen single bond (C—O). This correlates perfectly with the discharge reaction —C═O+Na⁺+e→—C—O—Na which involves the breaking of double bond and the formation of single bond. After charge, the C1s XPS resembles again that for original CP-Acid. This again correlates very well with the charge reaction —C—O—Na→—C═O+Na⁺+e. This also indicates that the breaking/formation of carbon-oxygen double bond is in fact reversible.

The analysis result of Na content on CP-Acid is also consistent with carbon-oxygen bond change during discharge/charge. In FIG. 5B, which includes a wide scan XPS spectrum, the Na signal increases significantly on CP-Acid electrode after discharge, and then disappears after charge. The results from high-resolution XPS provide quantitative information: after discharge, Na content increases from 0 for original CP-Acid to 6.5%; after charge, Na content decreases back to ˜0 (0.2%). Therefore, the charge storage mechanism of CP-Acid electrode is mainly the redox reaction between carbon oxygen surface functional groups and Na ions. In some embodiments, the double-layer capacitor mechanism seen in CP can also be present in CP-Acid (they both have the same surface area). For example, up to 50% of the capacity can be stored in sodium ions adsorbed to the surface of the substrate rather than being bound to surface functional groups.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method for operating a sodium-based energy storage cell comprising sodium ions, an anode, and a cathode comprising a substrate, the method comprising binding sodium ions to surface functional groups attached to surfaces of the substrate during discharge cycles and releasing sodium ions from the surface functional groups during charge cycles.

2. The method of claim 1, wherein the surface functional groups comprise oxygen.

3. The method of claim 1, wherein the surface functional groups comprise sulfur.

4. The method of claim 1, wherein the substrate comprises carbon.

5. The method of claim 1, further comprising transferring sodium ions to and/or from an anode comprising sodium.

6. The method of claim 5, wherein the anode comprises a sodium metal, a sodium alloy, a sodium intercalation compound, carbon, and combinations thereof.

7. The method of claim 1, further comprising storing up to 50% of storage cell capacity in sodium ions adsorbed directly on the substrate surface.

8. The method of claim 1, wherein the binding further comprises preferentially binding sodium ions to surface functional groups relative to intercalating the sodium ions in the substrate.

9. A method for operating a sodium-based energy storage cell comprising sodium ions, an anode comprising sodium, and a cathode comprising a substrate, the method comprising transferring sodium ions between the anode and the cathode, preferentially binding sodium ions to surface functional groups attached to surfaces of the substrate during discharge cycles relative to intercalating sodium ions into the substrate, and releasing sodium ions from the surface functional groups during charge cycles.

10. A sodium-based energy storage cell comprising sodium ions, an anode, and a cathode comprising a substrate, the storage cell characterized by surface functional groups attached to surfaces of the substrate and by the sodium ions bound to the surface functional groups during discharge cycles.

11. The sodium-based storage cell of claim 10, wherein the storage cell is a super-capacitor.

12. The sodium-based storage cell of claim 10, wherein the surface functional groups comprise oxygen.

13. The sodium-based storage cell of claim 10, wherein the surface functional groups comprise sulfur.

14. The sodium-based storage cell of claim 10, wherein the substrate comprises carbon.

15. The sodium-based storage cell of claim 10, wherein the anode comprises sodium.

16. The sodium-based storage cell of claim 15, wherein the anode comprises a sodium metal, a sodium alloy, a sodium intercalation compound, carbon, and combinations thereof.

17. The sodium-based storage cell of claim 10, having a storage cell capacity, wherein up to 50% of the storage cell capacity is stored in sodium ions adsorbed directly on the substrate surface.

18. The sodium-based storage cell of claim 10, wherein the sodium ions are charge carriers between the cathode and the anode.
